(19) United States
(12) Patent Application Publication
(10) Pub. No.: US 2005/0060183 A1
(43) Pub. Date: Mar. 17, 2005

(54) System and method for providing feedback for social compatibility

(76) Inventor: Robert K. Haupt, Springville, UT (US)

Correspondence Address: John R. Thompson;STOEL RIVES LLP, Suite 1100, 201 South Main Street, Salt Lake City, UT, 84111, US

(21) Appl. No.: 10/976,444

(22) Filed: Oct. 29, 2004

Related U.S. Application Data
(63) Continuation-in-part of application No. 10/236,422, filed on Sep. 6, 2002.

(51) Int. Cl. G06F 17/60

(52) U.S. Cl. 705/1; 705/14; 705/26

(57) ABSTRACT

The present invention provides feedback for users participating in an on-line social forum. Users are matched to one another based on compatibility. Matched users are able to correspond to one another through a messenger service provided by a server. Matched users receive a token which allows the submission of a feedback entry. Feedback entries are submitted with the token which is verified for validity. A feedback report is generated for a corresponding user based on submitted feedback entries.

### RELATED APPLICATIONS

This application claims priority to U.S. patent application Ser. No. 10/236,422 entitled “System and Method for Providing References for Social Introduction” filed on Sep. 6, 2002 and which is hereby incorporated by reference.

### FIELD OF THE INVENTION

The invention relates to on-line dating and social introduction services including forums for real time interactive correspondence.

### RELEVANT TECHNOLOGY

The innovation of the Internet has provided enhanced venues for marketing, shopping, bidding, research, correspondence, and social interaction. Browsing web sites is a routine hobby practiced by many. Internet use has impacted nearly all aspects of modern day society with its convenient access, numerous applications, and increased reliability and speed. The Internet has created a forum whereby individuals may interact, correspond, conduct business, and socialize with others whom they would likely not otherwise meet. Not constrained to geographical boundaries or distances, the Internet provides opportunities not previously experienced.

Enhanced communication applications is just one of the many advantages of the Internet. Indeed, many individuals maintain relationships over the web through chat groups, messenger services, and email. These relationships may continue for months or years without the parties physically meeting one another. Relationships may continue after relocations because geographic distances are no longer an obstacle to correspondence. Furthermore, enhanced searching and convenient access allows individuals to find one another after a number of years. For example, distant relatives, old friends, alumni, and others may be reunited through the use of the Internet.

Certain chat groups exist to promote interaction between individuals having common traits. For example, chat groups exist for hobbies, occupations, recreations, religions, and so forth. Participation in a chat group allows individuals of a like mind to share knowledge, experience, sentiments, and so forth to promote education, pleasure, and socialization.

Commercial social introduction and dating services have also entered the Internet community to provide on-line forums. Dating services have long existed to provide opportunities for participants to find compatible partners. Such services have varying degrees of success depending on their ability to match participants. Rather than matching participants, some social introduction services allow participants to interact with one another as they desire. Such interaction works well with the Internet wherein participants may access a web server which is in communication with a database that contains participant files. Each file may contain certain information about the participant. A participant may browse and search the files for a person of interest. Searches may be based on numerous parameters including sex, age, geographic location, and so forth.

A participant may establish a file and be selective of the information provided therein. In this manner, a participant may maintain a degree of confidentiality. A reviewing participant may solicit social interaction with another by sending correspondence through the web server. The web server may maintain the confidentiality of the receiving participant's email and forward the correspondence. The receiving participant may review the correspondence, the originating participant's file, and then decide if he/she wishes to respond. Eventually, favorable electronic correspondence and mutual consent may result in a face-to-face meeting.

A common concern about on-line social interaction is that little is known about the other party. A participant may be uncomfortable, concerned, or otherwise reluctant about meeting another party even after substantial correspondence. A participant may even be reluctant to correspond with another if the participant knows nothing more than the other party's file.

Some commercial forums allow participants to list references in their file. References are an age-old method for providing assurances that an individual possesses admirable qualities. A participant may solicit references from friends and acquaintances to include in the participant's file. The references may be submitted electronically to the database or directly to the requesting participant. It is common for the references to be filtered by the participant before the references are placed in the file. Thus, a participant may eliminate questionable and negative references and retain only positive references. The retained references may not provide the desired objectivity. A reviewing participant is not assured that the references are reliable.

It would, therefore, be an advancement in the art to provide a system and method for providing references that are reasonably reliable to provide much needed feedback to subscribers of an on-line service. Such a system and method are disclosed and claimed herein.

### BRIEF DESCRIPTION OF THE DRAWINGS

In order that the manner in which the above-recited and other advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram representation of one embodiment of a system of the present invention;

FIG. 2 is a block diagram illustrative of data flows in accordance with the present invention;

FIG. 3 is a block diagram illustrative of additional data flows in accordance with the present invention;

FIG. 4 is a flow diagram illustrating steps performed in accordance with a method of the present invention;

FIG. 5 is a flow diagram illustrating steps performed in accordance with another method of the present invention; and

FIG. 6 is a

### DETAIL DESCRIPTION OF THE EMBODIMENTS

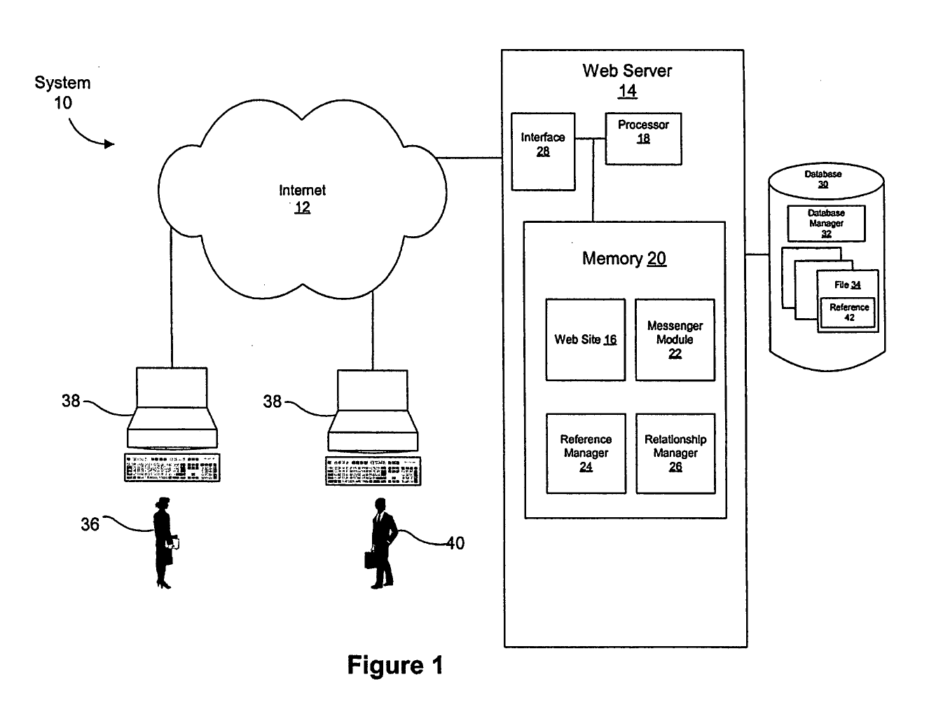

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 to 5 and is not intended to limit the scope of the invention, as claimed, but is merely representative of presently preferred embodiments of the invention.

Referring to FIG. 1, a system 10 is shown for providing social interaction between users at remote locations. The system 10 is for use with a global computer network, or more commonly referred to as the Internet 12. One of skill in the art will appreciate that the system 10 described herein is for exemplary purposes only and variances are still within the scope of the invention. The system 10 includes a web server 14 that provides a variety of applications such as a web site 16 to provide a social forum for users. The web server 14 may also include additional applications to enable real time chat, instant messaging, and other forms of correspondence.

The web server 14 includes a processor 18 for performing methods of the present invention. The processor 18 is in communication with a memory 20 that stores applications, such as the web site 16, that are executable by the processor 18. The memory 20 may include non-volatile memory, RAM, ROM and other forms of memory for performing functions of the present invention.

The memory 20 may further include a messenger module 22 to enabling correspondence between users, a reference manager 24 to list references for users, and a relationship manager 26 to provide relationship proximities between users. The applications 22, 24, 26 will be further discussed below. The applications 16, 22, 24, 26 need not be entirely resident within the memory 20 or the server 14 and may be partially distributed throughout the system 10. One of skill in the art will appreciate that the memory 20 may contain numerous other applications and those described herein are for illustrative purposes.

The processor 18 is further in communication with an interface 28 that couples to the Internet and provides a gateway. Such interfaces that provide protocol conversion are well known in the art.

The web server 14 is in electrical communication with a database 30. The database 30 may be resident within the web server 14, in proximity to the web server 14, or at a remote location. The database 30 may be configured in various formats such as a relational or hierarchal database. The database 30 includes a database manager 32 that locates and retrieves files 34 as requested by the web server 14. The files 34 may include a brief summary of the user such as name, occupation, physical characteristics, hobbies, preferences, pictures, and other information common for social introduction. The web site 16 operates in conjunction with the database 30 to provide files 34 to users.

A user 36 with an Internet-enabled device 38, such as a personal computer operating a browser, accesses the web server 14. The device 38 enables viewing of the web site 16 so that a user 36 may participate in the provided social forum. A user 36 may enter an initial log-in page on the web site 16 and enter in a user name and password. The web server 14 then confirms the name and password as is well known in the art. The server 14 further confirms that the user 36 has a current subscription to the forum.

A user 36 may then browse through the various files 34 accessible through the server 14 and database 30. The web site 16 may provide a preliminary view of each subscriber and link for an expanded view. Several preliminary views may be displayed on a web page in a convenient manner. Activating a corresponding link may then display more information from a file 34.

The messenger module 22 enables and manages correspondence between users. An originating user 36 may view a file 34 and activate a corresponding link to compose and send a message to a receiving user 40. The message may be embodied as text, graphics, audio (such as voice-over-IP), or even video. Methods of generating and transmitting such messages so as to be compatible with Internet protocol are well known in the art.

The message is electronically transmitted to the web server 14. The messenger module 22 may immediately send the message to the receiving user 40. If the receiving user 40 is on-line, the receiving user 40 may respond and the messenger module 22 may effect real time communication between the users 36, 40. If the receiving user 40 is not on-line, the messenger module 22 may store the message in memory 20 or the database 30. When the receiving user 40 logs into the user's account, the user 40 may be notified of the message. In this manner, the actual email addresses or other correspondence information need not be used and remains confidential. Users may share actual contact information when they so desire.

Each file 34 may also contain one or more references 42. A reference 42 may be created by any subscriber who knows the corresponding user. A reference 42 may include how the author knows the user, how long the author has known the user, how well the author knows the user, and additional information regarding the user's qualities, characteristics, and so forth. The system 10 may require that the reference be in a certain format. For example, the system may include mandatory fields and a field for free text. The format should be sufficient to allow an author to provide worthwhile information about a user.

As a user 36 views a file 34, references 42 may be displayed in their entirety or links may be provided to view each reference. Such configurations are largely determined by viewing and browsing convenience.

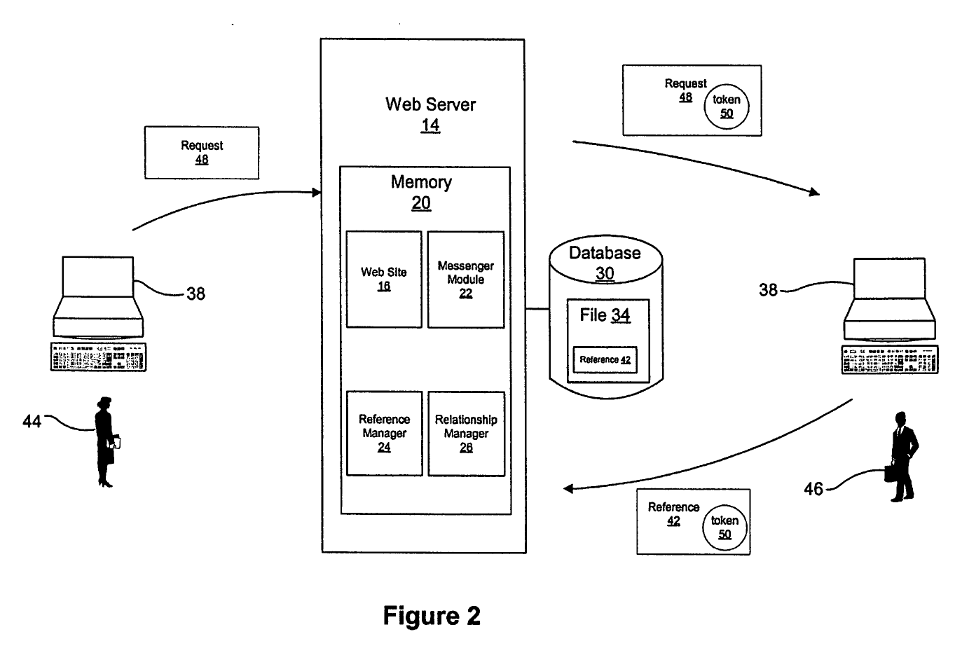

Referring to FIG. 2, a data flow diagram is shown that illustrates creation of a reference 42 in accordance with the present invention. Although not specifically illustrated, communication may be accomplished over the Internet 12. A user 44 may wish to include a reference 42 in the user's file 34. The user 44 may initiate contact with another user 46 through the server 14 to request a reference 42. The user 46 may be referenced herein as the selected user or the authoring user interchangeably. In so doing, the requesting user 40 may generate a request 44 and transmit the request 44 to the server 14.

The server 14 may provide an option on the web site 16 to create a request 44. The user 44 may activate a link to request a reference 42 which executes the reference manager 24. The reference manager 24 responds by prompting for who the reference author will be. Upon receiving a name or other identification, the reference manager 24 searches the database 30 for a matching user. The reference manager 24 returns with a matching user and confirms the identity from the user 44. The reference manager 24 then confirms that the user 46 is a current subscriber to the system 10. This may require that the user 46 be current in subscription fees. The reference manager 24 further verifies that the requesting user 44 and the selected user 46 are separate individuals as far as the database 30 is able to confirm.

The reference manager 24 then generates a request 48 that includes a token 50. The request 48 includes information corresponding to a file 34 corresponding to the user 44. The token 50 authorizes a one time creation of a reference 42. The server 14 then transmits the request 48 to the receiving user 46. Upon logging into the server 14, the receiving user 46 may be notified of the request 48. The user 46 prepares a reference 42 that may be in a prescribed format provided by the server 14.

The user 46 then transmits the reference 42 and the token 50 to the server 14. The server 14 receives the reference 42 and the token 50. The server 14 confirms the token 50 is genuine and consumes the token 50. The reference 42 is sent to the database 30 where it is stored in the appropriate file 34. The authoring user 46 may not create another reference 42 for that user 44 once the token 50 is transmitted to the server 14. The requesting user 44 is not able to filter the submitted reference 42 before the reference 42 is stored in the file 34.

The reference 42 may remain in the file 34 until a predetermined expiration time transpires. Alternatively, the reference 42 may remain in the file 34 as long as the user 44 or the authoring user 46 maintain current accounts with the system 10. The reference 42 may also be edited or removed in a manner described below.

One of skill in the art will appreciate that the process shown above is exemplary and variances would still be included within the scope of the invention. For example, an authoring user 44 may send a message to the user 46 expressing a willingness to author a reference. The user 44 may then respond by generating a request 48 and accompanying token 50. In another implementation, an authoring user 46 may generate a message that includes an un-validated token. The user 44 receives the message and the token and validates the token. The token is then included within a request which is sent to the server 14. The process may then continue similar to that described above.

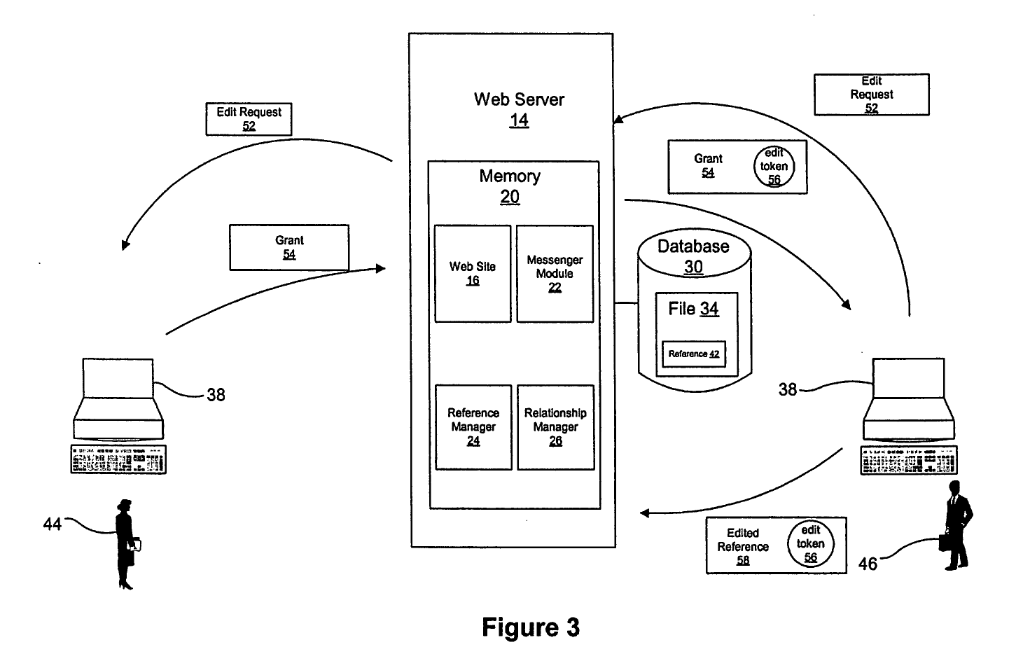

Referring to FIG. 3, a data flow diagram is shown that illustrates an editing process of a reference 42. An authoring user 46 may wish to edit a reference 38. This may reflect new experiences that the authoring user 46 has had with the user 44 or to change noted errors. The authoring user 46 submits an edit request 52 to the server 14 which is then transmitted to the user 44. The user 44 receives the edit request 52 and then decides whether or not to grant permission. If the user 44 agrees, the user 44 responds by transmitting a grant 54 to the server 14. This may be accomplished by the server 14 prompting the user 44 with the edit request 52 and notifying the user 44 of the authoring user 46.

The server 14 generates an edit token 56 and includes the edit token 56 within the grant 54. The grant 54 and the edit token 56 are sent to the authoring user 46. The authoring user 46 is notified of the received grant 54 and prepares an edited reference 58. The edited reference 58 and the edit token 56 are sent to the server 14. The edit token 56 is consumed and the edited reference 58 is placed in the file 34.

Alternatively, the authoring user 46 may transmit the edit token 56 for a one-time access to the reference 42. The server 14 verifies and consumes the edit token 56 and the authoring user 46 accesses and edits the reference 42 with an update. The edited reference 58 may remain in the file 34 for a certain amount of time, until another edit, or until the user 44 or authoring user 46 cease their subscription with the system 10.

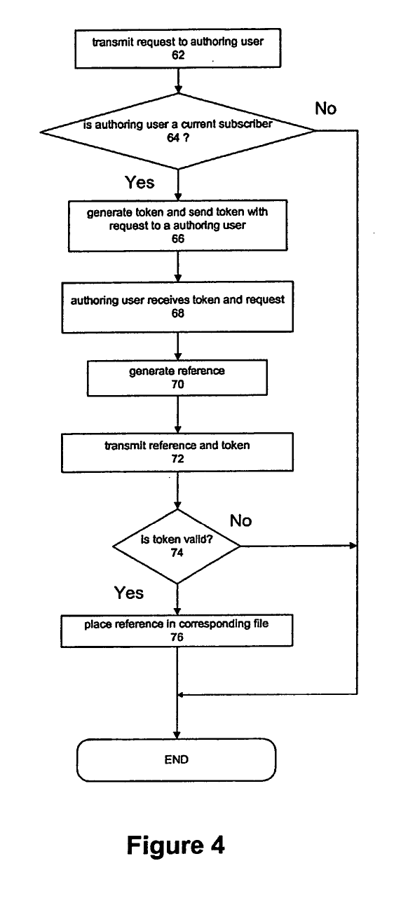

Referring to FIG. 4 a flow diagram illustrating one embodiment of a process 60 of the present invention is shown. A requesting user 44 transmits 62 a request 48 to an intended authoring user 46 and the request 48 is sent to the server 14. The server 14 verifies 64 that the intended authoring user 46 is a current subscriber and is not the same individual as the requesting user 44. The server 14 then generates 66 a token 50 and includes the token 50 within the request 48. In an alternative implementation, the device 38 includes an application to generate a token 50 that is sent with the request 48 directly to the intended authoring user 46.

The authoring user 46 receives 68 the request 48 and the token 50. Receipt of the request 48 and token 50 may occur when the authoring user 46 logs onto the server 14. The authoring user 46 generates 70 a reference 42 and transmits 72 the reference 42 with the token 50 to the server 14. The server 14 verifies 74 the token 50 and places 76 the reference 42 in a file 34 corresponding to the user 44.

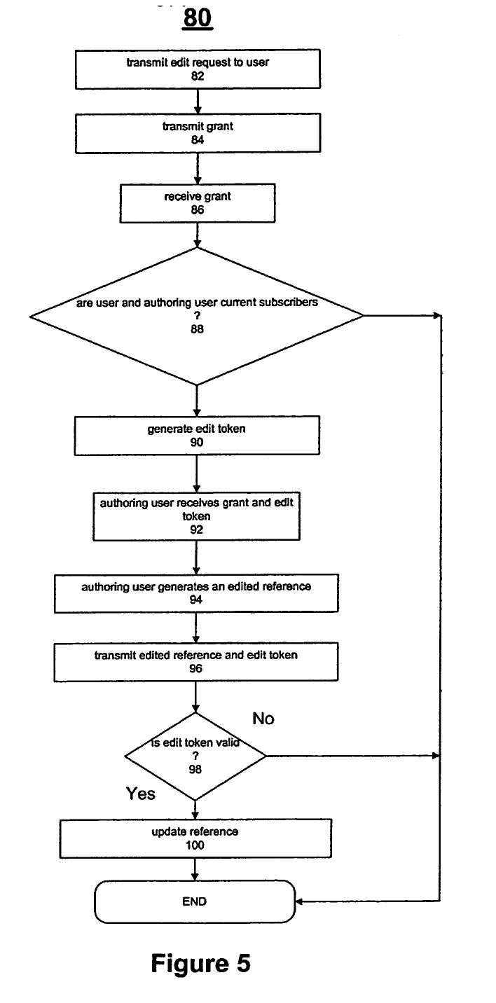

Referring to FIG. 5 a flow diagram is shown illustrating one embodiment of a process 80 for editing a reference. If an authoring user 46 desires to edit the reference 42, the authoring user 46 transmits 82 an edit request 52 to the user 44. The edit request 52 may be sent directly to the user 44 or through the server 14. The user 44 decides whether to allow editing, and if so, transmits 84 a grant 54 to the server 14. The server 14 receives 86 the grant 54 and verifies 88 if the user 44 and the authoring user 46 are current subscribers.

The server 14 generates 90 an edit token 56 that is included with the grant 54. In generating 90 the edit token 56 the server 14 may also confirm that both users 44, 46 are current subscribers of the system 10. Alternatively, the device 38 may be enabled to generate an edit token 56 in which case the grant 54 and edit token 56 may be transmitted directly to the authoring user 46.

The authoring user 46 receives 92 the grant 54 and the edit token 56 and generates 94 an edited reference 58. The authoring user 46 then transmits 96 the edited reference 58 with the edit token 56 to the server 14. The server 14 verifies 98 that the edit token 56 is valid, consumes the edit token 56, and updates 100 the reference 42 with the edited reference 58. In an alternative implementation, the edit token 56 may be used to grant access to the reference 42 which is then updated by the authoring user 46.

A user participating in the system 10 may have one or more references included in the user's file. The references provide a unique method of connecting or linking users to one another. Users who do not know one another may have mutual acquaintances who do know one another. Thus, certain users may be closer to each other's social circle than they may otherwise know. The present invention provides a process for determining how close participating users may be to one another's social circle.

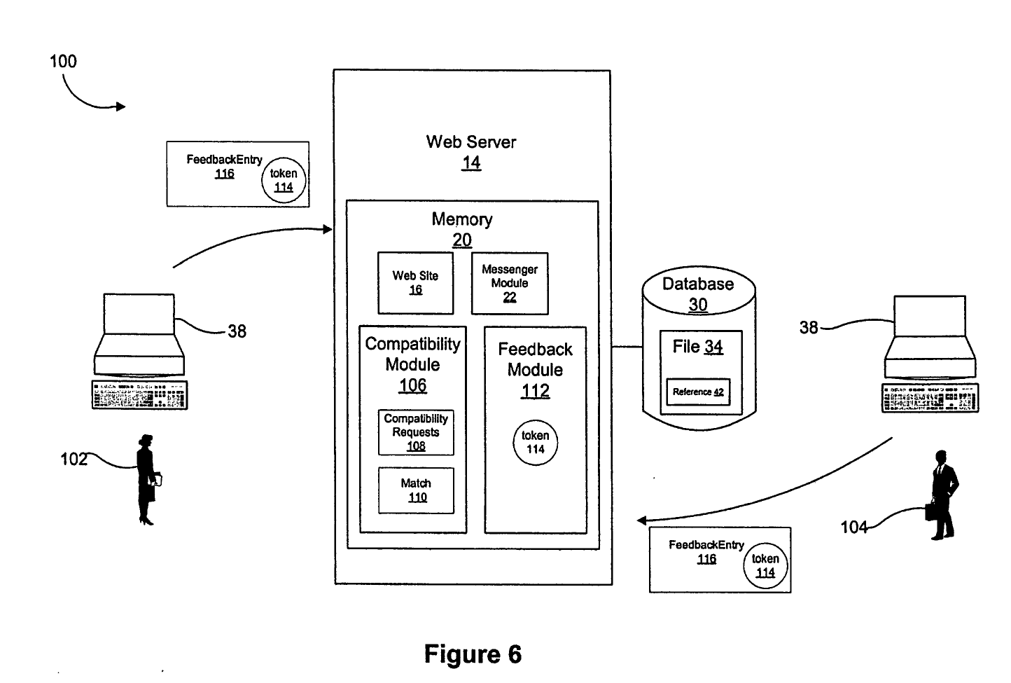

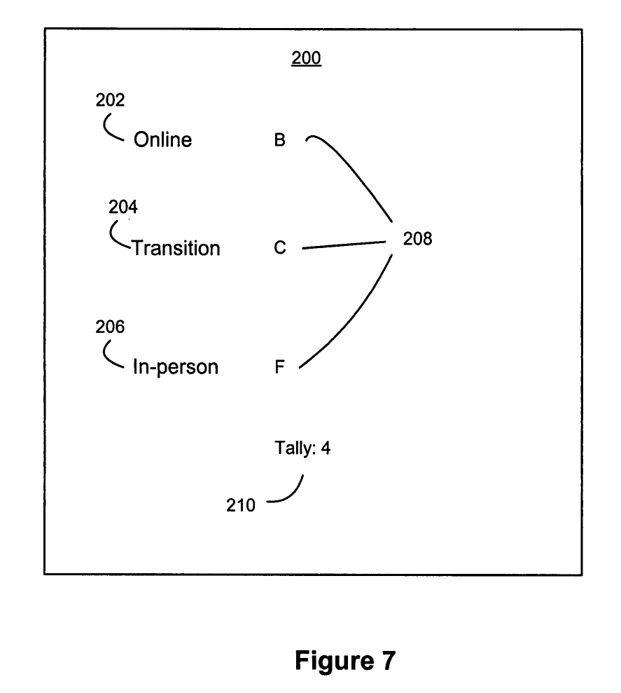

Referring to FIG. 6, an alternative system 100 and a data flow diagram is shown that illustrates generation of feedback in accordance with the present invention. Although not specifically illustrated, communication may be accomplished over the Internet 12. Users 102, 104, access the web server 14 through use of internet-enabled device 38 to participate in the social forum provided by the web site 16. As in previously discussed embodiments, the web site 16 confirms that the users 102, 104 are current subscribers of the forum in order to participate. The device 38 enables viewing of the web site 16 so that a user 36 may participate in the provided social forum. The memory 20 includes a compatibility module 106 that generates compatibility recommendations 108 based on files 34 in the database 30. The compatibility module 106 may include any engine or application that matches user profiles.

Users 102, 104 receive compatibility recommendations 108 from the server 14 and have the option of agreeing to a match. If the users both 102, 104 respond to the server 14 by agreeing to the match, then the compatibility module 108 generates a match 110 between the two users 102, 104. Upon generation of a match 110, the users 102, 104 are able to correspond with one another through the server 14. Correspondence between the users 102, 104 may be managed by the messenger module 22. The match 110 may be discontinued if either user 102, 104 elects to do so. Upon termination of a match 110, correspondence between the users 102, 104 is disabled by the messenger module 22.

Upon generation of a match 110, a feedback module 112 generates a token 114 for both users 102, 104. The token 114 is sent to and stored within the respective devices 38. The token 114 validates whether feedback may be entered for a user and corresponds to the appropriate user. A user 102, 104 may generate a feedback entry 116 by requesting this action from the server 14. The server 14 may respond with a format that includes prompts for feedback. A user 102, 104 responds with a feedback entry 116 and the token 114. In so doing, the token 114 is removed from the device 38. The feedback module 112 reviews the validity of the token 114, consumes the token 114. The feedback module 112 then updates the user's file 34 with the feedback entry 116. A feedback entry is not edited and does not include opinions or comments by system personal. The feedback entries 116 are scalar in their ratings and do not include free-text. Free text may, however, be submitted in private messaging between users who have been commonly matched with a user.

Referring to FIG. 7, an embodiment of a graphical representation of a feedback report 200 is shown. A feedback report 200 is a compilation of feedback entries 116 that is generated by the feedback module 112. Accessibility to the feedback report 200 may be limited to users who have been matched to the user corresponding to the report. A feedback report 200 includes behavioral data for different categories. In one embodiment, the feedback report 200 may include three main categories: Online 202, Transition 204, and In-Person 206. Online 202 relates to behavior experienced in on-line messaging. Transition 204 relates to whether a user uses or observes safety protocols in requesting/arranging face-to-face meetings. In-person 206 relates to whether not whether a user's personal data in a file 34 is accurate. Personal data may include photograph, age, occupation, and so forth. In-person 206 further includes how a user presents oneself in face-to-face meetings. Additional sub-categories may be included underneath each of the main categories. For example, for Online 200, subcategories may include “does not use profanity in messages” and “does not use sexual themes in message.” One of skill in the art will appreciate that the feedback report 200 may be embodied in various ways, all of which are included within the scope of the invention. Furthermore, categories and subcategories may be added, amended, and deleted as desired to better serve the needs of users.

Ratings 208 for different categories may be expressed as letter grades and displayed in a vertical format corresponding to the categories. The ratings 208 may be averages from submitted feedback entries 116. A tally 210 may also be displayed to indicate the number of users who have submitted feedback. If desired, the ratings 208 may be “clickable” to allow a user to open a new webpage and view individual entries rather than an average. An individual entry may also be clickable which directs a browser to a form where the user may compose and send an inquiring message to the user who submitted the entry. Usernames of the sender and recipient may be hidden from one another to maintain confidentiality. Thus, a recipient who submitted an entry may receive an inquiring message from a sender who is reviewing the feedback report 200. The recipient would not know who sent the inquiring message, but will know that it is from another user who has been matched to the user corresponding to the feedback report 200.

Behavior is in continual evolution, so a feedback entry 116 may be updated by the authoring user. An update may replace any previous feedback entry 116 rather than being cumulative. As such, one user with a skewed perspective cannot inflict disproportionate damage if the user is only one of twenty who have contributed feedback about a particular user. A user 102 may update the user's opinion of user 104 so long as the match 110 between users 102, 104 has not been mutually negated. If user 104 negates the match 110, but user 102 has not, then user 102 is allowed to update a feedback entry 116 relating to user 104 for some reasonable, predetermined amount of time.

The continued existence of a match 110 allows for messaging between users 102, 104 and allows for updating of feedback entries 116. In one embodiment, a user is required to submit a request to the feedback module 112 for a feedback entry update. The feedback module 112 confirms with the compatibility module 108 that a match 110 still exists. Upon confirmation, the feedback module 112 generates and sends a token 114 to the requesting user. The user authors an update feedback entry 116 that is sent to the feedback module 112 to replace an earlier entry. If desired to avoid the repetitive steps of requesting and issuing tokens, alternative methods may be used. For example, tokens 114 may be generated periodically and automatically sent to the devices 38. New consumable tokens 114 may be sent daily, weekly, or monthly to devices 38 to allow updates if desired by the users. In an alternative embodiment, the token 114 remains resident on the device 38 as long as the match 110. A duplicate token 114 is sent to the server 14 with a feedback entry 116 or with an updated feedback entry 116. In another embodiment, tokens 114 are not used and the match 110 itself maintains the ability to submit a feedback entry 116 and continue messaging between matched users. The messenger module 22 and the feedback module 112 both rely on the compatibility module 108 to confirm the existence of the match 110.

The present invention provides a technique for providing feedback on past behavior. Predators and dishonest users will have difficulty functioning in the interactive on-line forum because their past behavior will follow them. As such, recently matched users will be advised of past behavior and have increased confidence in interacting with users with positive feedback reports 200.

The invention may be embodied in other specific forms without departing from its spirit or essential characteristics. The described embodiments are to be considered in all respects only as illustrative and not restrictive. Any explanations provided herein of the scientific principles employed in the present invention are illustrative only. The scope of the invention is, therefore, indicated in the appended claims rather than by the foregoing description. All changes within the meaning and range of the claims are to be embraced within their scope.

1. A system for providing feedback to users participating in an on-line social forum over a global computer network, the system comprising:
an interface for communicating with the global computer network;
a processor coupled to the interface; and
a memory coupled to the processor, the memory including computer executable instruction code executable by the processor for performing a method comprising,
establishing a match between first and second users based on compatibility,
enabling messenger correspondence between the users,
transmitting a token to each user,
receiving a token and a feedback entry from a first user,
verifying that the token is valid,
consuming the token, and
upon verification and consumption of the token generating a feedback report relating to the second user based on the feedback entry.

2. The system of claim 1, wherein the method further comprises verifying that the users are current subscribers of the social forum.

3. The system of claim 1, further comprising a database in electrical communication with the interface, processor, and memory, the database storing files corresponding to the users, and wherein the method further comprises storing the feedback entry in a file corresponding the second user.

4. The system of claim 1, wherein the method further comprises:
periodically generating additional tokens based on predetermined time intervals, and
transmitting the additional tokens to the users.

5. The system of claim 1, wherein the method further comprises:
receiving a request from the first user to submit an updated feedback entry, upon confirming the existence of a match, transmitting a token to the first user, and receiving the token and an updated feedback entry.

6. The system of claim 1, wherein the method further comprises:
establishing a match between the second user and a third user based on compatibility, and enabling the third user to view the feedback report.

7. The system of claim 6, wherein the method further comprises enabling messenger correspondence between the third user and the first user.

8. A method for providing feedback to users participating in an on-line social forum over a global computer network, the method comprising:
establishing a match between first and second users based on compatibility;
enabling messenger correspondence between the users;
transmitting a token to each user;
receiving a token and a feedback entry from a first user;
verifying that the token is valid;
consuming the token; and
upon verification and consumption of the token generating a feedback report relating to the second user based on the feedback entry.

9. The method of claim 8, further comprising verifying that the users are current subscribers of the social forum.

10. The method of claim 8, further comprising storing the feedback entry and feedback report in a file corresponding to the second user.

11. The method of claim 8, further comprising:
periodically generating additional tokens based on predetermined time intervals; and
transmitting the additional tokens to the users.

12. The method of claim 8, further comprising:
receiving a request from the first user to submit an updated feedback entry;
upon confirming the existence of a match, transmitting a token to the first user; and
receiving the token and an updated feedback entry.

13. The method of claim 8, further comprising:
establishing a match between the second user and a third user based on compatibility; and
enabling the third user to view the feedback report.

14. The method of claim 13, further comprising enabling messenger correspondence between the third user and the first user.

15. A computer program product comprising program code for performing a method for providing feedback to users participating in an on-line social forum over a global computer network, the method comprising:
establishing a match between first and second users based on compatibility;
enabling messenger correspondence between the users;
transmitting a token to each user;
receiving a token and a feedback entry from a first user;
verifying that the token is valid;
consuming the token; and
upon verification and consumption of the token generating a feedback report relating to the second user based on the feedback entry.

16. The computer program product of claim 15, wherein the method further comprises verifying that the users are current subscribers of the social forum.

17. The computer program product of claim 15, wherein the method further comprises storing the feedback entry and feedback report in a file corresponding to the second user and resident in a database.

18. The computer program product of claim 15, wherein the method further comprises:
periodically generating additional tokens based on predetermined time intervals; and
transmitting the additional tokens to the users.

19. The computer program product of clam 15, wherein the method further comprises:
receiving a request from the first user to submit an updated feedback entry;
upon confirming the existence of a match, transmitting a token to the first user; and
receiving the token and an updated feedback entry.

20. The computer program product of claim 15, wherein the method further comprises:
establishing a match between the second user and a third user based on compatibility; and
enabling the third user to view the feedback report.

21. The computer program product of claim 20, wherein the method further comprises enabling messenger correspondence between the third user and the first user.

22. A method for providing feedback to users participating in an on-line social forum over a global computer network, the method comprising:
establishing a match between first and second users based on compatibility;
upon verification of the match, enabling messenger correspondence between the users;
receiving a feedback entry from a first user;
upon verification of the continued existence of the match, entering the feedback entry into a file corresponding to the second user; and
generating a feedback report relating to the second user based on the feedback entry.

23. The method of claim 22, further comprising verifying that the users are current subscribers of the social forum.

24. The method of claim 22, further comprising:
receiving an updated feedback entry from the first user;
upon confirming the existence of a match, accepting the updated feedback entry; and
generating an updated feedback report relating to the second user based on the updated feedback entry.

25. The method of claim 22, further comprising:
establishing a match between the second user and a third user based on compatibility; and
enabling the third user to view the feedback report.

26. The method of claim 25, further comprising enabling messenger correspondence between the third user and the first user.
